(19) United States
(12) Patent Application Publication
(10) Pub. No.: US 2020/0393347 A1
(43) Pub. Date: Dec. 17, 2020

(54) Imaging Method of Internal Defects in Longitudinal Sections of Trees

(71) Applicant: Jiangnan University, Wuxi (CN)

(72) Inventors: Guanghui LI, Wuxi (CN); Lei LIU, Wuxi (CN)

(21) Appl. No.: 17/005,394

(22) Filed: Aug. 28, 2020

Related U.S. Application Data
(63) Continuation of application No. PCT/CN2019/087022, filed on May 19, 2019.

(30) Foreign Application Priority Data
Mar. 22, 2019 (CN) 201910221698.2

(51) Int. Cl. G01N 3/06; G06T 11/40

(52) U.S. Cl. CPC G01N 3/062; G01N 2203/0032; G01N 2203/006; G06T 11/40

(57) ABSTRACT

The disclosure herein discloses an imaging method of internal defects in longitudinal sections of trees, and belongs to the field of nondestructive testing of trees. The method includes the following steps: with the propagation time of stress waves in a tree as input data, dividing an imaging plane into a predetermined number of grid cells to establish initial velocity distribution in the imaging plane; then performing multiple iterations using a linear propagation model; following each iteration, adjusting the velocity distribution in the imaging plane using the SIRT algorithm; constraining the velocity of each grid cell using maximum and minimum velocity constraints and fuzzy constraints based on grid cell groups, and ending iteration until the final velocity distribution is in good fit with the measured data; by comparing the velocity value of the grid cell at this moment with the reference value of the tested healthy tree, determining an abnormal grid cell; and then performing secondary smoothing processing on the grid cell imaging to obtain the defect location inside the tree. The method can accurately detect the defective area of the tree, and has less false detection areas and good imaging effect.

### TECHNICAL FIELD

The disclosure herein relates to an imaging method of internal defects in longitudinal sections of trees, and belongs to the field of nondestructive testing of trees.

### BACKGROUND

Nondestructive testing, also referred to as non-destructive inspection, uses different physical and mechanical properties or chemical properties of materials to test and inspect object-related properties (such as shape, displacement, stress, optical properties, fluid properties, mechanical properties, etc.) without destroying the internal and external structures and characteristics of the target object, especially to measure various defects.

The nondestructive testing of trees usually uses stress waves for testing. Stress waves refer to elastic mechanical waves which are generated under the action of stress after an object is impacted and can propagate inside the object. In China, stress waves are first applied to the testing of properties and defects of rock, soil, concrete, etc., and later to the field of nondestructive testing of trees by forestry scientists and technicians.

At present, extensive domestic and foreign researches have been conducted on the cross-sectional tomographic imaging testing of internal defects in trees, but there are few researches on longitudinal sectional imaging of trees. The results of longitudinal sectional imaging of trees are of great significance for judging the extent of longitudinal extension of internal defects of trees, and at the same time can provide a reference for the internal three-dimensional imaging of trees.

### SUMMARY

In order to judge the extent of longitudinal extension of internal defects of trees and provide a reference for the internal three-dimensional imaging of trees, the disclosure herein provides an imaging method of internal defects in longitudinal sections of trees, including:

SS1: establishing a corresponding imaging plane based on the data of a measured tree, dividing the imaging plane into grid cells with the same size, and assigning an initial velocity value to each grid cell; calculating the velocity reference value of stress waves propagating in each direction inside a healthy tree, and then obtaining the healthy reference velocity value v of each grid cell in the imaging plane;

SS2: after each grid cell has the initial velocity value, according to the initial velocity distribution in the imaging plane, simulating the propagation of the stress waves inside the tree using a linear propagation model, and adjusting the velocities of the grid cells in the imaging plane using simultaneous iterative reconstruction technique (SIRT) algorithm; in the adjustment process, constraining the velocities of the grid cells in the imaging plane using the maximum and minimum velocity values and a fuzzy constraint mechanism based on the grid cell group; obtaining the adjusted velocity v′ of each grid cell in the imaging plane, that is, obtaining the final velocity distribution in the imaging plane; wherein the value range of the fuzzy constraint factor of each grid cell is [0.5, 1];

SS3: comparing the adjusted velocity v′ of each grid cell with the healthy reference velocity value v of each grid cell obtained in S1, and when

$$\frac{v - {v}^{′}}{v}$$

exceeds a predetermined threshold, marking the grid cell corresponding to v′ as an abnormal grid cell; and

SS4: performing secondary image smoothing processing on the marked abnormal grid cell to determine the internal defect image of the longitudinal section of the tree.

The second objective of the disclosure herein is to provide an imaging method of internal defects in longitudinal sections of trees, further including:

S1: establishing a corresponding imaging plane based on the data of a measured tree, dividing the imaging plane into grid cells with the same size, assigning a same initial velocity value to each grid cell, and obtaining the initial velocity distribution in the imaging plane;

S2: according to the initial velocity distribution in the imaging plane, simulating the propagation of the stress waves inside the tree using a linear propagation model, and adjusting the velocities of the grid cells in the imaging plane using simultaneous iterative reconstruction technique (SIRT) algorithm; in the adjustment process, constraining the velocities of the grid cells in the imaging plane using the maximum and minimum velocity values and a fuzzy constraint mechanism based on the grid cell group; obtaining the adjusted velocity v′ of each grid cell in the imaging plane; and

S3: determining whether each grid cell is an abnormal grid cell according to the adjusted velocity v′ of each grid cell in the imaging plane.

Optionally, the method further includes: calculating the velocity reference value of stress waves propagating in each direction inside a healthy tree, and then obtaining the healthy reference velocity value v of each grid cell in the imaging plane; the S3 is: comparing the adjusted velocity v′ of each grid cell in the imaging plane with the healthy reference velocity value v of each grid cell in the imaging plane, calculating

$$\frac{v - {v}^{′}}{v} ,$$

and when

$$\frac{v - {v}^{′}}{v}$$

exceeds a predetermined threshold, marking the grid cell corresponding to v′ as an abnormal grid cell.

Optionally, the method further includes: performing secondary image smoothing processing on the abnormal grid cell to obtain the internal defect image of the measured tree.

Optionally, the S2 includes:

S21: calculating the velocity increment of each grid cell by the SIRT algorithm, and applying the velocity increment to the current velocity value of each grid cell to obtain a new velocity value;

S22: in the process of velocity adjustment, imposing the maximum and minimum velocity value constraints on the velocity values of the grid cells; when the obtained new velocity value exceeds the maximum or minimum limit value, assigning the limit value exceeded to the new velocity value;

at the same time, in the process of velocity adjustment, imposing fuzzy constraints based on the grid cell group on the velocity values of the grid cells; according to the fuzzy constraint factor of each grid cell, linearly combining the inversion velocity value of each grid cell following each iteration with the fully constrained velocity value of each grid cell, and using the combined velocity value as the new velocity value of the grid cell; and

S23: when the last iteration is over, obtaining the adjusted velocity v′ of each grid cell in the imaging plane.

Optionally, the step of calculating the velocity reference value v(θ, α) of propagation of stress waves in each direction inside a healthy tree, and then obtaining the healthy reference velocity value v of each grid cell in the imaging plane includes:

calculating v(θ, α) according to equation (1), and calculating v according to equation (2);

$$\begin{matrix}v ( θ , α ) = {v}_{l} \times {v}_{R} \times ( - 0.2 {α}^{2} + 1 ) \text{/} [ {v}_{l} \times {sin}^{2} θ + {v}_{R} \times ( - 0.2 {α}^{2} + 1 ) \times {cos}^{2} θ ] & ( 1 ) \\ {v}_{i} = \frac{{\sum }_{j = 1}^{M} {v}_{ij}}{M} ( i = 1 , 2 , … , N ) & ( 2 )\end{matrix}$$

where vₗ is the velocity of the stress wave propagating in the longitudinal direction of the tree, v_{R} is the velocity value of the stress wave propagating in the radial direction of the tree, α is the angle between the longitudinal section and the radial section corresponding to the propagation directions, θ is the corresponding stress wave propagation direction angle, vᵢ represents the healthy reference velocity value of the i^{th} grid cell, vᵢⱼ is the velocity reference value of the j^{th} propagation path passing through the i^{th} grid cell, the velocity value can be calculated by equation (1), M is the total number of paths passing through the i^{th} grid cell, and N is the number of grid cells in the imaging plane.

Optionally, in the step of when

$$\frac{v - {v}^{′}}{v}$$

exceeds the predetermined threshold, marking the grid cell corresponding to v′ as an abnormal grid cell, the predetermined threshold is 15%.

Optionally, the value range of the fuzzy constraint factor of each grid cell is [0.5, 1].

Optionally, the value of the fuzzy constraint factor of the grid cell near the center of the tree is greater than the value of the fuzzy constraint factor of the grid cell near the edge of the tree.

Optionally, before establishing the corresponding imaging plane based on the data of a measured tree data, the method further includes:

deploying a predetermined number of sensors at random distances along the longitudinal direction at both ends of the trunk of the measured tree; connecting the sensors to a stress wave signal acquisition instrument, and obtaining the propagation time data between every two sensors at both ends by means of pulse hammer tapping; and measuring the diameter of the tree and the position information of the sensors in the longitudinal section.

The third objective of the disclosure herein is to provide an application method of the method above in the field of nondestructive testing, and the application method includes: constructing a nondestructive testing platform; deploying a certain number of sensors at random distances along the longitudinal direction at both ends of the trunk of the measured tree; connecting the sensors to a stress wave signal acquisition instrument; tapping one of the sensors with a pulse hammer every time, so that the sensor at the other end receives a corresponding signal, and the acquisition instrument records the acquired stress wave propagation time; repeating the process until all the sensors are tapped, and obtaining the propagation time data between every two sensors at both ends; and at the same time, measuring the diameter of the tree and the sensor position information in the longitudinal section with a tape measure for subsequent longitudinal sectional imaging.

Optionally, in the step of assigning an initial velocity value to each grid cell, the velocity value is greater than 0.

The disclosure herein has the following beneficial effects.

With the propagation time of stress waves in a tree as input data, an imaging plane is divided into a certain number of grid cells to establish initial velocity distribution in the imaging plane; then multiple iterations are performed using a linear propagation model; following each iteration, the velocity distribution in the imaging plane is adjusted using simultaneous iterative reconstruction technique (SIRT) algorithm; the velocity of each grid cell in the imaging plane is constrained using maximum and minimum velocity constraints, meanwhile the velocity of each grid cell is constrained by fuzzy constraints based on grid cell groups, and iteration is ended until the final velocity distribution is in good fit with the measured data; the velocity value of the grid cell at this moment is compared with the reference value of the measured healthy tree, and whether a certain grid cell has abnormal data or normal data is judged; and then secondary smoothing processing is performed on the image of the grid cells to obtain the defect location inside the tree. The method can accurately detect the defective area of the tree, and has less false detection areas and good imaging effect.

### BRIEF DESCRIPTION OF FIGURES

In order to describe the technical solutions more clearly in the examples of the disclosure herein, the following will briefly introduce the drawings that need to be used in the description of the examples. Obviously, the drawings in the following description are only some examples of the disclosure herein. For a person of ordinary skill in the art, other drawings can be obtained from these drawings without creative effort.

FIG. 1 is a schematic structural diagram of an experimental platform for nondestructive testing in the method of the disclosure herein.

FIG. 2 is a schematic diagram of a longitudinal imaging plane in the disclosure herein.

FIG. 3 is a schematic diagram of a fuzzy constraint matrix in the disclosure herein.

FIG. 4A is a log image; FIG. 4B is a longitudinal sectional image generated by the Du's method; FIG. 4C is a longitudinal sectional image generated by the LSQR method; and FIG. 4D is a longitudinal sectional image obtained by testing using the method provided by the present application.

FIG. 5 is a schematic diagram of a three-dimensional coordinate system of a tree trunk.

### DETAILED DESCRIPTION

In order to make the objectives, technical solutions, and advantages of the disclosure herein clearer, the examples of the disclosure herein will be described in further detail below in conjunction with the accompanying drawings.

### Example 1

The present example provides an imaging method of internal defects in longitudinal sections of trees. The method includes the following steps: with the propagation time of stress wave in a tree as input data, an imaging plane was divided into a certain number of grid cells to establish initial velocity distribution in the imaging plane; then multiple iterations were performed using a linear propagation model; following each iteration, the velocity distribution in the imaging plane was adjusted using SIRT algorithm; the velocity of each grid cell in the imaging plane was constrained using maximum and minimum velocity constraints, meanwhile the velocity of each grid cell was constrained by fuzzy constraints based on grid cell groups, and iteration is ended until the final velocity distribution is in good fit with the measured data; the velocity value of the grid cell at this moment was compared with the reference value of a measured healthy tree, and whether a certain grid cell has abnormal data or normal data was judged; and secondary smoothing processing was performed on the image of the grid cells to obtain the defect location inside the tree.

Specifically, when nondestructive testing was performed on trees, a nondestructive testing platform was constructed first. Referring to FIG. 1, a certain number of sensors were deployed at random distances along the longitudinal direction at both ends of the trunk of the measured tree, and the sensors were connected to an FAKOPP stress wave signal acquisition instrument produced in Hungary. One of the sensors was tapped with a pulse hammer every time, so that the sensor at the other end received a corresponding signal, and the acquisition instrument recorded the acquired stress wave propagation time. The process was repeated until all the sensors are tapped, and the propagation time data between every two sensors at both ends was obtained. At the same time, the diameter of the tree and the sensor position information in the longitudinal section were measured with a tape measure for subsequent longitudinal sectional imaging.

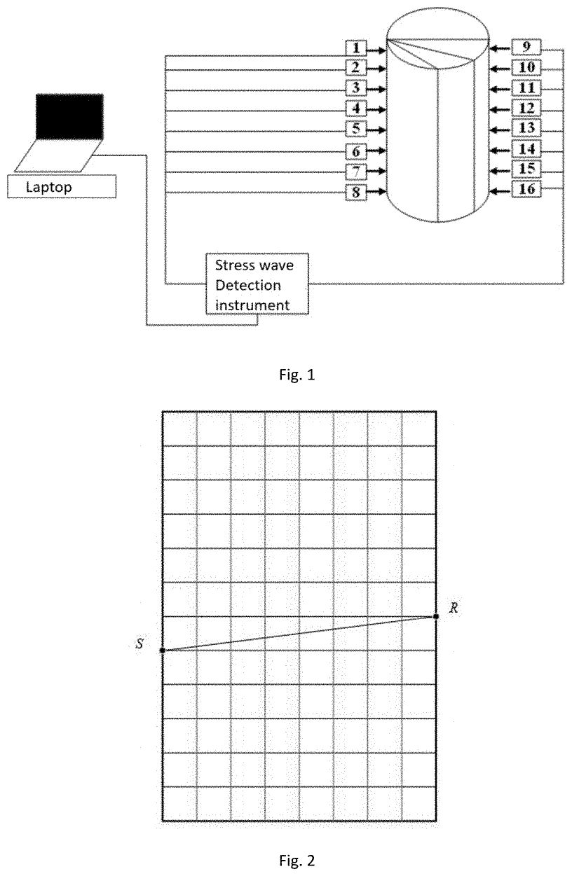

As shown in FIG. 2, after the propagation time data between every two sensors, the diameter of the tree and the sensor position information in the longitudinal section were acquired, the subsequent longitudinal sectional imaging work was started.

According to the measured tree diameter and sensor position information, the imaging plane as shown in FIG. 2 was established. The imaging plane was divided into a certain number of grid cells. Each grid cell has the same size. To make the imaging results more accurate, the grid cells were usually divided into grid cells with smaller sizes, but meanwhile it is necessary to ensure that each grid cell has a propagation path passing therethrough as much as possible.

A stress wave propagation velocity model was established. A uniform initial velocity value was assigned to each grid cell in the imaging plane as shown in FIG. 2, and the initial velocity value usually used a random positive value greater than 0. Thereby, the initial velocity distribution in the imaging plane was established.

After the initial velocity distribution in the imaging plane was established, the velocity reference value v(θ, α) of stress waves propagating in each direction in a healthy tree was calculated, and further the healthy reference velocity value v of each grid cell in the imaging plane was obtained.

The velocity reference value v(θ, α) of stress waves propagating in each direction in the healthy tree can be calculated by the following equation (1)

v(θ,α)=vₗ×v_{R}×(−0.2α²+1)/[vₗ×sin² θ+v_{R}×(−0.2α²+1)×cos² θ] (1)

where vₗ is the velocity of the stress wave propagating in the longitudinal direction of the tree, v_{R} is the velocity value of the stress wave propagating in the radial direction of the tree, α is the angle between the longitudinal section and the radial section corresponding to the propagation directions, θ is the corresponding stress wave propagation direction angle. The specific α and θ are shown in corresponding locations in FIG. 5.

The computing mode of the healthy reference velocity value v of each grid cell is as the following equation (2):

$${v}_{i} = \frac{{\sum }_{j = 1}^{M} {v}_{ij}}{M} ( i = 1 , 2 , … , N ) \qquad ( 2 )$$

where vᵢ represents the healthy reference velocity value of the i^{th} grid cell, vᵢⱼ is the velocity reference value of the j^{th} propagation path passing through the i^{th} grid cell, the velocity value can be calculated using equation (1), M is the total number of paths passing through the i^{th} grid cell, and N is the number of grid cells in the imaging plane.

According to the initial velocity distribution in the imaging plane, the propagation of the stress wave in the tree was simulated using a linear propagation model. The velocities of the grid cells in the imaging plane were adjusted using simultaneous iterative reconstruction technique (SIRT) algorithm. In the adjustment process, the velocities of the grid cells in the imaging plane were constrained using the maximum and minimum velocity values and the fuzzy constraint mechanism based on the grid cell group. The adjusted velocity v′ of each grid cell in the imaging plane was obtained.

Specifically, the velocity increment of each grid cell was calculated by the SIRT algorithm, and the velocity increment was applied to the current velocity value of each grid cell to obtain a new velocity value. Refer to Geophysical Tomography Using Wavefront Migration and Fuzzy Constraints published in 1994 for calculation of the velocity increment of each grid cell using the SIRT algorithm.

In the process of velocity adjustment, the maximum and minimum velocity value constraints were imposed on the velocity values of the grid cells. When the obtained new velocity value exceeded the maximum or minimum limit value, the limit value exceeded was assigned to the new velocity value.

At the same time, in the process of velocity adjustment, fuzzy constraints based on the grid cell group were imposed on the velocity values of the grid cells. According to the fuzzy constraint factor of each grid cell, the inversion velocity value of each grid cell following each iteration was linearly combined with the fully constrained velocity value of each grid cell, and the combined velocity value was used as the new velocity value of the grid cell.

When the last iteration was over, the adjusted velocity v′ of each grid cell in the imaging plane was obtained.

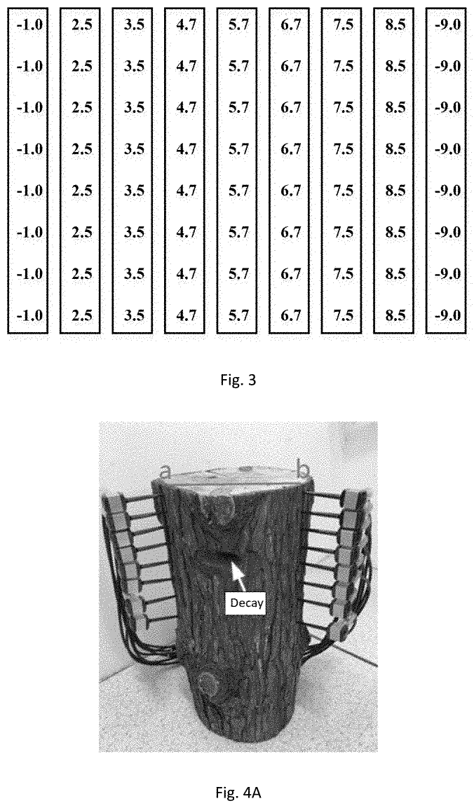

In the above velocity adjustment process, as shown in FIG. 3, the integer part of the fuzzy constraint factor of each grid cell represents the type of constraint imposed: a negative value represents that the velocity value of the grid cell is maintained at a fixed value, and the algorithm of the present application chooses to fix the fixed value as the reference velocity value of the grid cell; and a positive value represents that the velocity of the grid cell is constrained by the velocity of the grid cell group where the grid cell is located, and different integers represent different grid cell groups.

The velocity of each grid cell group is the average of the reference average values of all grid cells in the same grid cell group.

The fractional part of the grid cell constraint factor represents the fuzzy degree of the imposed constraint: 0 represents full constraint is used, and greater than 0 represents fuzzy constraint is imposed; and the larger the decimal part, the higher the fuzzy degree and the greater the uncertainty. The algorithm of the present application chooses to impose smaller fuzzy constraints on the grid cell group close to the bark to conform to the law of longitudinal propagation of stress waves as much as possible. For the part closer to the center of the tree, where the wood is harder and denser, the probability of occurrence of a velocity abnormal area is greater, and the uncertainty is greater, greater fuzzy constraints are imposed to better adapt to the internal conditions of the tree and enhance the realism of imaging.

The end condition of the above iteration for adjusting the velocity of each grid cell using the SIRT algorithm is: when the root mean square error between the measured time data and the time data obtained from the inversion stabilizes, the iteration ends. The stabilization means that, in the final stage of the iteration, the root mean square error fluctuates above and below a certain value, generally, about 3 times.

After the final velocity distribution is obtained, the final velocity is compared with the healthy reference velocity value v of each grid cell calculated according to the equation (2). The value of

$$\frac{v - {v}^{′}}{v}$$

is calculated. When

$$\frac{v - {v}^{′}}{v}$$

exceeds a predetermined threshold, the grid cell corresponding to v′ is marked as an abnormal grid cell.

Specifically, it is set that when

$$\frac{v - {v}^{′}}{v} \geq 15 \% ,$$

the grid cell corresponding to v′ is marked as an abnormal grid cell.

All the grid cells marked as abnormal grid cells are smoothed using the mean value method to generate the final image of the longitudinal section of the tree, and the health status of the defective part in the tree is judged.

To verify the testing effect of the method of the present application, the following general imaging methods are compared with the method disclosed herein:

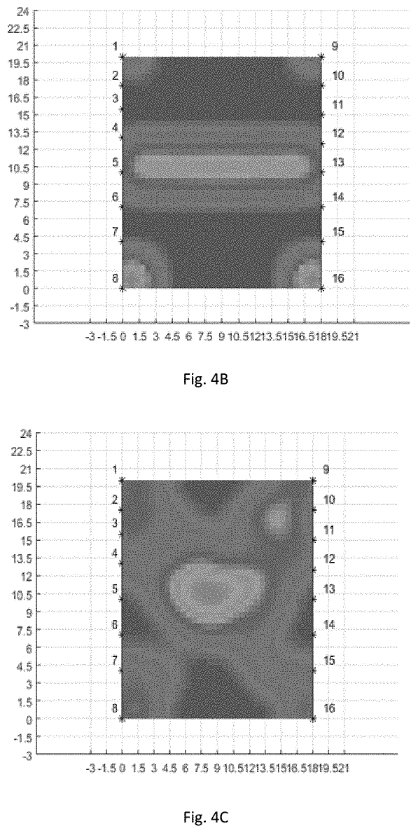

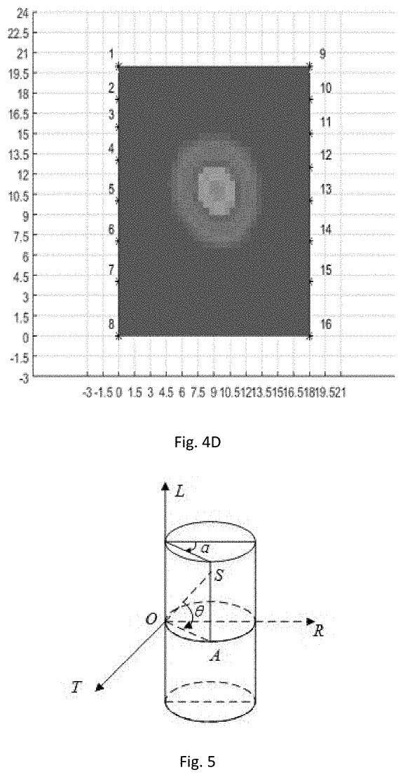

Referring to FIG. 4A-D, FIG. 4A is a log image. 16 sensors are used for testing data, sensors 1-8 are deployed along an a-end in the longitudinal direction in FIG. 4A, and sensors 9-16 are deployed along a b-end in the longitudinal direction in FIG. 4A; FIG. 4B is a longitudinal sectional image generated by the Du's method; FIG. 4C is a longitudinal sectional image generated by the LSQR method; and FIG. 4D is a longitudinal sectional image obtained by testing using the method provided by the present application.

For the introduction of the Du's method, reference may be made to Stress Wave Tomography of Wood Internal Defects using Ellipse-Based Spatial Interpolation and Velocity Compensation published in 2015.

For the introduction of the LSQR method, reference may be made to An Algorithm for Sparse Linear Equations and Sparse Least Squares published in 1982.

It can be seen from the figure that the Du's method detects the defect in the log sample, but has much false detection which are quite different from the real condition. The improved LSQR detects the approximate location of the defect, is more accurate than the Du's method, but still has much false detection in the figure. However, the method provided in the present application detects the defect more accurately, the shape location is the closest to the real condition of the defect, the algorithm has almost no false detection area, and the imaging effect is better.

Part of the steps in the examples of the disclosure herein can be implemented by software, and the corresponding software program can be stored in a readable storage medium, such as an optical disc or a hard disc.

What is claimed is:

1. A method, comprising imaging internal defects in a longitudinal section of a tree, using steps below:
step S1: establishing a corresponding imaging plane based on measured data of the tree, dividing the imaging plane into grid cells with the same size, assigning a same initial velocity value to each of the grid cells, and obtaining an initial velocity distribution in the imaging plane; wherein the measured data of the tree comprises propagation time data of a stress wave inside the tree, a diameter of the tree, and position information of sensors arranged in the longitudinal section;
step S2: according to the initial velocity distribution in the imaging plane, simulating propagation of the stress wave inside the tree by using a linear propagation model, and adjusting the velocities of the grid cells in the imaging plane by using a simultaneous iterative reconstruction technique (SIRT) algorithm; in the adjustment process, constraining the velocities of the grid cells in the imaging plane by using maximum and minimum velocity values and a fuzzy constraint mechanism based on a grid cell group; obtaining an adjusted velocity v′ of each of the grid cells in the imaging plane; and
step S3: determining whether each of the grid cells is an abnormal grid cell according to the adjusted velocity v′ of each of the grid cells in the imaging plane.

2. The method of claim 1, wherein the S1 further comprises: calculating the velocity reference value of the stress wave propagating in each direction inside a healthy tree, and then obtaining a healthy reference velocity value v of each of the grid cells in the imaging plane; and the S3 further comprises: comparing the adjusted velocity v′ of each of the grid cells in the imaging plane with the healthy reference velocity value v of each of the grid cells in the imaging plane, calculating
$$\frac{v - {v}^{′}}{v} ,$$
and when
$$\frac{v - {v}^{′}}{v}$$
exceeds a predetermined threshold, marking the grid cell corresponding to v′ as an abnormal grid cell.

3. The method of claim 2, further comprising: performing secondary image smoothing processing on the abnormal grid cell to obtain an internal defect image of the tree.

4. The method of claim 3, wherein the S2 further comprises:
step S21: calculating a velocity increment of each of the grid cells by the SIRT algorithm, and applying the velocity increment to a current velocity value of each of the grid cells to obtain a new velocity value;
step S22: in the process of velocity adjustment, imposing the maximum and minimum velocity value constraints on the velocity values of the grid cells; when the obtained new velocity value exceeds a maximum or minimum limit value, assigning the limit value exceeded to the new velocity value;
at the same time, in the process of velocity adjustment, imposing fuzzy constraints based on the grid cell group on the velocity values of the grid cells; according to a fuzzy constraint factor of each of the grid cells, linearly combining an inversion velocity value of each of the grid cells following each iteration with a fully constrained velocity value of each of the grid cells, and using the combined velocity value as the new velocity value of the grid cell; and
step S23: when a last iteration is over, obtaining the adjusted velocity v′ of each of the grid cells in the imaging plane.

5. The method of claim 4, wherein the calculating the velocity reference value of propagation v(θ, α) of the stress wave in each direction inside the healthy tree, and then obtaining the healthy reference velocity value v of each of the grid cells in the imaging plane comprises: calculating v(θ, α) according to equation (1), and calculating v according to equation (2);
$$\begin{matrix}v ( θ , α ) = {v}_{l} \times {v}_{R} \times ( - 0.2 {α}^{2} + 1 ) \text{/} [ {v}_{l} \times {sin}^{2} θ + {v}_{R} \times ( - 0.2 {α}^{2} + 1 ) \times {cos}^{2} θ ] & ( 1 ) \\ {v}_{i} = \frac{{\sum }_{j = 1}^{M} {v}_{ij}}{M} ( i = 1 , 2 , … , N ) & ( 2 )\end{matrix}$$
where vₗ is a velocity of the stress wave propagating in a longitudinal direction of the tree, v_{R} is a velocity value of the stress wave propagating in a radial direction of the tree, α is an angle between a longitudinal section and a radial section corresponding to the propagation directions, θ is a corresponding stress wave propagation direction angle, vᵢ represents a healthy reference velocity value of an i^{th} grid cell, vᵢⱼ is a velocity reference value of a j^{th} propagation path passing through the i^{th} grid cell, the velocity value can be calculated by equation (1), M is a total number of paths passing through the i^{th} grid cell, and N is a number of grid cells in the imaging plane.

6. The method of claim 5, wherein in the step of when
$$\frac{v - {v}^{′}}{v}$$
exceeds the predetermined threshold, marking the grid cell corresponding to v′ as an abnormal grid cell, the predetermined threshold is 15%.

7. The method of claim 6, wherein a value range of the fuzzy constraint factor of each of the grid cells is [0.5, 1].

8. The method of claim 7, wherein a value of the fuzzy constraint factor of the grid cell near a center of the tree is greater than a value of the fuzzy constraint factor of the grid cell near an edge of the tree.

9. The method of claim 8, wherein before establishing the corresponding imaging plane based on the measured data of the tree, the method further comprises:
deploying a predetermined number of sensors at random distances along a longitudinal direction at both ends of a trunk of the tree; connecting the sensors to a stress wave signal acquisition instrument, and obtaining propagation time data between every two sensors at both ends by means of pulse hammer tapping; and measuring the diameter of the tree and the position information of the sensors in the longitudinal section.

10. The method of claim 1, further comprising: constructing a nondestructive testing platform; deploying a certain number of sensors at random distances along a longitudinal direction at both ends of a trunk of a measured tree; connecting the sensors to a stress wave signal acquisition instrument; tapping one of the sensors with a pulse hammer every time, so that the sensor at the other end receives a corresponding signal, and the acquisition instrument records acquired stress wave propagation time; repeating the tapping process until all the sensors are tapped, and obtaining propagation time data between every two sensors at both ends; and at the same time, measuring a diameter of the tree and sensor position information in a longitudinal section with a tape measure for subsequent longitudinal sectional imaging.

11. The method of claim 10, wherein in the assigning the initial velocity value to each of the grid cells, the velocity value is greater than 0.
